(19) United States
(12) Patent Application Publication
(10) Pub. No.: US 2010/0085609 A1
(43) Pub. Date: Apr. 8, 2010

(54) APPARATUS AND METHOD FOR PROVIDING FAX SERVICE IN AN IP MULTIMEDIA SYSTEM

(75) Inventor: Jin Woo Hong, Seoul (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/576,020

(22) Filed: Oct. 8, 2009

(30) Foreign Application Priority Data
Oct. 8, 2008 (KR) 0098491/2008

(51) Int. Cl. H04N 1/32

(52) U.S. Cl. 358/442

(57) ABSTRACT

A method and an apparatus for providing a fax service in an IP Multimedia Subsystem (IMS) are provided. A method of a FAX Application Server (AS) for providing the fax service in the IMS includes receiving a fax transmission request from a User Equipment (UE) or a fax machine, interconnecting the UE and the fax machine over an IMS network, and sending a fax to transmit and receive between the UE and the fax machine through the connection.

### PRIORITY

This application claims priority under 35 U.S.C. §119(a) to a Korean patent application filed in the Korean Intellectual Property Office on Oct. 8, 2008 and assigned Serial No. 10-2008-0098491, the contents of which are incorporated herein by reference.

### BACKGROUND OF THE INVENTION

1. Field of the Invention

The present invention relates generally to methods and apparatuses for providing a facsimile (fax) service in an Internet Protocol (IP) Multimedia Subsystem (IMS), and more particularly, to a method and an apparatus for providing a fax transmission service at a general IMS User Equipment (UE) using a separate server for the fax service.

2. Description of the Related Art

A conventional fax transmission uses a Public Switched Telephone Network (PSTN), which is a circuit switching network. Recent times have seen the commercialization of the fax provided by a system using an IP network as the backbone network. The circuit switching network provides the fax transmission service using the T.30 protocol, and a packet switching network provides the fax transmission service using the T.38 protocol.

The conventional fax transmission service using the IP network suffers from several shortcomings. For example, in the fax transmission service over the IP network, since an originating terminal sends and receives the fax by supporting the T.38 protocol, terminals not supporting the T.38 protocol cannot use the fax transmission service. In addition, it is necessary for the originating terminal to support a function of converting a file to transmit to an image file format suitable for the fax transmission and a function of storing the received fax as an image file. The fax transmission service over the IP network is not feasible when the recipient terminal is deregistered or does not respond to the fax transmission signal, and a voice call is impossible while the fax transmission and reception is conducted between the terminals.

Since the T.38 protocol limits the codec in relation with the audio compression, the efficiency of the network resource is lower than the general voice call. Moreover, the conventional fax transmission service utilizes the same Public User Identity (PUI) of the IMS subscriber as used in the multimedia service. Disadvantageously, the subscriber for the fax reception needs to select the conditions for the fax transmission service and the conditions for the multimedia service by controlling the IMS UE.

### SUMMARY OF THE INVENTION

The present invention has been made to address at least the above problems and/or disadvantages and to provide at least the advantages described below. Accordingly, an aspect of the present invention is to provide a method and an apparatus for providing a fax service in an IMS network.

An aspect of the present invention is to provide a method and an apparatus for providing a fax service regardless of T.38 protocol support of an IMS terminal, using a separate server for the fax service over an IMS network.

An aspect of the present invention is to provide a method and an apparatus for realizing fax transmission at a fax machine over an IMS network regardless of registration or deregistration of a recipient terminal, and the present invention also provides a method and an apparatus for allowing telephone call of a terminal regardless of fax transmission and reception in an IMS network.

According to the present invention, a method of a FAX Application Server (AS) for providing a fax service in an IMS includes receiving a fax transmission request from a UE or a fax machine, interconnecting the UE and the fax machine over an IMS network, and sending a fax to transmit and receive between the UE and the fax machine through the connection.

According to the present invention, a method of a UE for providing a fax service in an IMS includes sending a fax transmission request message comprising one or more fax machine numbers and a fax file to a FAX AS of an IMS network, and receiving a fax file from a particular fax machine via the FAX AS.

According to the present invention, an apparatus of a FAX AS for providing a fax service in an IMS includes a controller for receiving a fax transmission request from a UE or a fax machine, and controlling to send a fax to transmit and receive between the UE and the fax machine by interconnecting the UE and the fax machine over an IMS network.

According to the present invention, an apparatus for providing a fax service in an IMS includes a controller for controlling to send a fax transmission request message comprising one or more fax machine numbers and a fax file to a FAX AS of an IMS network, and to receive a fax file from a particular fax machine via the FAX AS.

Other aspects, advantages, and salient features of the invention will become apparent to those skilled in the art from the following detailed description, which, taken in conjunction with the annexed drawings, discloses embodiments of the invention.

### BRIEF DESCRIPTION OF THE DRAWINGS

The above and other aspects, features and advantages of certain exemplary embodiments the present invention will become more apparent from the following detailed description taken in conjunction with the accompanying drawings, in which:

FIG. 1 illustrates a system configuration for providing a fax service according to of the present invention;

FIG. 2 illustrates signal flows for sending the fax from an IMS UE to a fax machine in the system according to the present invention;

FIG. 3 illustrates signal flows for sending the fax from the fax machine to the IMS UE in the system according to the present invention;

FIG. 4 illustrates a fax transmission and reception method of the UE in the system according to the present invention;

FIGS. 5A and 5B illustrate operations of a FAX AS for providing the fax service in the system according to the present invention;

FIG. 6 illustrates a fax transmission and reception method of the fax machine in the system according to the present invention;

FIG. 7 illustrates operations of an IM server for the fax service in the system according to the present invention;

FIG. 8 illustrates a block structure of the UE in the system according to the present invention;

FIG. 9 illustrates a block structure of the FAX AS in the system according to the present invention;

FIG. 10 illustrates a block structure of the fax machine in the system according to the present invention; and

FIG. 11 illustrates a block structure of the IM server in the system according to the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted for the sake of clarity and conciseness.

Embodiments of the present invention provide a method and an apparatus for providing a fax service using a separate server for the fax service in an IMS network.

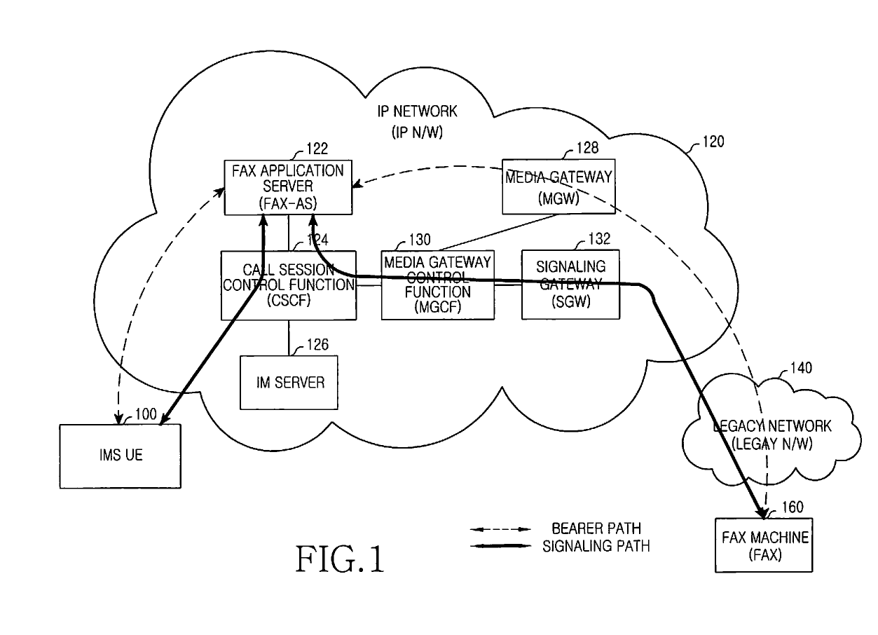

FIG. 1 illustrates a system configuration for providing the fax service according to the present invention. In FIG. 1, the solid arrow lines indicate a signaling path carrying signals for the fax transmission and reception, and the dotted arrow lines indicate a bearer path carrying fax data.

The system for providing the fax service of FIG. 1 includes an IMS UE 100, an IP network 120, a legacy network 140, and a fax machine 160. The IP network 120 includes a Cell Session Control Function (CSCF) 124, an IM server 126, a Breakout Gateway Control Function (not shown), a Media GateWay (MGW) 128, a Media Gateway Control Function (MGCF) 130, and a Signaling GateWay (SGW) 132. A FAX Application Server (FAX AS) 122 is further provided. The legacy network 140 can be a Packet Switched Telephone Network (PSTN) or a Public Land Mobile Network (PLMN).

The IMS UE 100 has a Public User Identity (PUI) for identifying a subscriber in the IMS network. The FAX AS 122 has a separate fax identifier dedicated to the fax service for the fax service subscriber. For having the “fax service only” fax identifier per subscriber with respect to a plurality of fax service subscribers, the FAX AS 122 stores a mapping table between the PUIs for the general subscriber identification and the fax service only fax identifiers. When an event for sending the fax to the fax machine 160 is performed, the IMS UE 100 transfers a file to send to the FAX AS 122. When the IM server 126 reports of the fax reception, the IMS UE 100 receives the fax by requesting the FAX AS 122 to forward the fax.

Upon receiving the file to send to the fax machine 160 from the IMS UE 100, the FAX AS 122 converts the file to a proper format of the fax transmission, transfers the converted file to the fax machine 160, and reports the transmission completion to the IM server 126. When receiving the fax identifier and the fax from the fax machine 160, the FAX AS 122 stores the received fax, confirms the PUI corresponding to the fax identifier from the pre-stored identifier mapping table, and reports the fax reception of the corresponding UE to the IM server 126. The FAX AS 122 receives the fax transmission request from the IMS UE 100 and transmits the stored fax.

The fax machine 160 receives the fax from the FAX AS 122. When the event for transmitting the fax to the IMS UE 100 is to be performed, the fax machine 160 transmits the fax to the fax identifier corresponding to the PUI of the IMS UE 100 to which the fax is to be transmitted.

When the completion of the fax transmission is reported from the FAX AS 122, the IM server 126 reports the fax transmission completion to the corresponding IMS UE 100. When being reported of the fax reception from the FAX AS 122, the IM server 126 reports the fax reception to the corresponding IMS UE 100.

Herein, the signals transmitted and received between the IMS UE 100 and the FAX AS 122 pass through the CSCF 124, and the signals transmitted and received between the FAX AS 122 and the fax machine 160 pass through the CSCF 124, the MGCF 130, and the SGW 132. The FAX AS 122 and the fax machine 160 send and receive the fax in the bearer path set via the MGW 128.

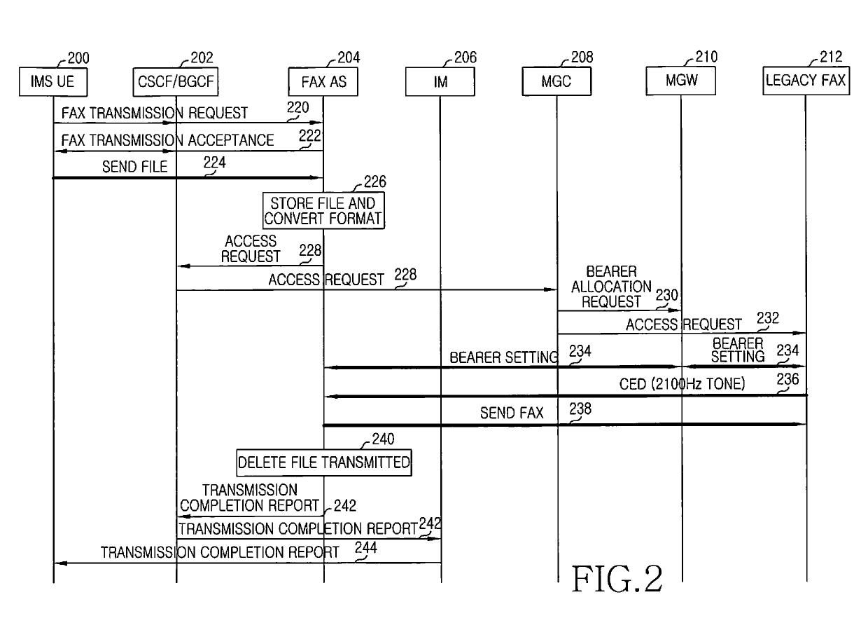

FIG. 2 illustrates signal flows for sending the fax from the IMS UE to the fax machine in the system according to the present invention. Here, several of the bold lines in FIG. 2 denote bearer path, and other lines in FIG. 2 denote signaling path.

When the fax transmission event is generated, the IMS UE 200 sends a fax transmission request message including a fax machine number of the legacy network to the FAX AS 204 in step 220. The FAX AS 204 sends a fax transmission acceptance message to the IMS UE 200 via the CSCF 202 in step 222. The fax transmission request message, which includes a plurality of fax machine numbers, can provide a group transmission service. The fax transmission request message and the fax transmission acceptance message transmitted and received between the IMS UE 200 and the FAX AS 204 pass through the CFCS 202.

The IMS UE 200 sends the file to transmit to the FAX AS 204 in step 224.

The FAX AS 204 receiving the file from the IMS UE 200 stores and converts the received file to a proper format of the fax transmission in step 226. When the format conversion is not possible or fails, the FAX AS 204 sends a message informing of the failure or the infeasibility of the fax transmission to the IMS UE 200 via the IM server 206.

When completing the file format conversion, the FAX AS 204 sends an access request message to the fax machine 212 in steps 228 and 232. The access request message is carried to the MGCF 208 via the CSCF 202 and is forwarded from the MGCF 208 to the fax machine 212. Upon receiving the access request message, the MGCF 208 requests the bearer allocation to the MGW 210 for the fax transmission and reception in step 230. The MGW 210 sets the bearer between the FAX AS 204 and the fax machine 212 in step 234.

Upon completing the bearer setting, the fax machine 212 transmits a 2100 Hz Called Station Identifier (CED) tone to the FAX AS 204 in step 236. The FAX AS 204 transmits the file converted to the proper format of the fax transmission to the fax machine 212 according to the fax transmission scheme in step 238.

The FAX AS 204 deletes the transmitted file in step 240, and reports the fax transmission completion to the IM server 206 via the CSCF 204 in step 242. The IM server 206 reports the fax transmission completion to the IM UE 200 via the CSCF 204 in step 244. After transmitting the file to the fax machine 212 in step 238, the FAX AS 204 may delete the corresponding file immediately or after storing the file for a time duration in step 240.

When the IMS UE 200 requests the group fax; that is, when the fax transmission request message includes the plurality of the fax machine numbers, steps 228 through 238 are repeated such that the FAX AS 204 sends the access request message to the plurality of the fax machines.

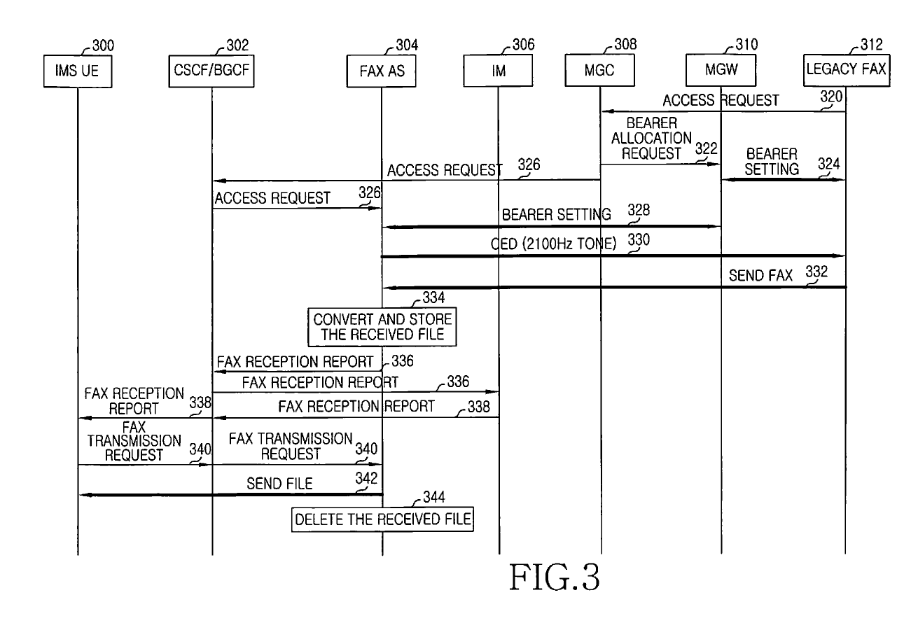

FIG. 3 illustrates signal flows for sending the fax from the fax machine to the IMS UE in the system according to the present invention.

When the fax transmission event is issued, the fax machine 312 sends the access request message including the fax identifier corresponding to the PUI of the recipient UE to the FAX AS 304 in steps 320 and 326. The access request message is delivered from the MGCF 308 to the CSCF 302 and then forwarded from the CSCF 302 to the FAX AS 304. Upon receiving the access request message including the fax identifier, the MGCF 308 requests the bearer allocation to the MGW 310 for the fax transmission and reception in step 322. The MGW 310 sets the bearer between the FAX AS 304 and the fax machine 312 in steps 324 and 328.

When the bearer is set, the FAX AS 304 transmits the 2100 Hz CED tone to the fax machine 312 in step 330. The fax machine 312 transmits the fax to the FAX AS 304 in step 332.

The FAX AS 304 converts the received fax to an image file and stores the image file in step 334. The FAX AS 304 reports the fax reception from the UE corresponding to the fax identifier to the IM server 306 in step 336. The message reporting of the fax reception is delivered to the IM server 306 via the CSCF 302. Herein, the FAX AS 304 can acquire the PUI of the UE corresponding to the fax identifier of the access request message by pre-storing the identifier mapping table including the PUI and the fax identifier of the IMS UE, and sends the PUI of the corresponding UE through the fax reception report message sent to the IM server 306.

The IM server 306 examines the registration status of the UE corresponding to the PUI of the fax reception report message. When the UE is registered, the IM server 306 reports the fax reception to the corresponding IMS UE 300 in step 338. When the UE is deregistered, the IM server 306 periodically monitors the registration status of the UE, and when the UE is registered, the IM server 306 reports the fax reception to the corresponding IMS UE 300. The message reporting of the fax reception is carried to the IMS UE 300 via the CSCF 302.

Being reported of the fax reception, the IMS UE 300 requests the file transmission to the FAX AS 304 in step 340. The FAX AS 304 sends the stored file to the IMS UE 300 in step 342. The file and the file transmission request message transmitted and received from the IMS UE 300 and the FAX AS 304 proceed through the CSCF 302.

The FAX AS 304 deletes the corresponding file immediately or after storing for a time duration in step 344.

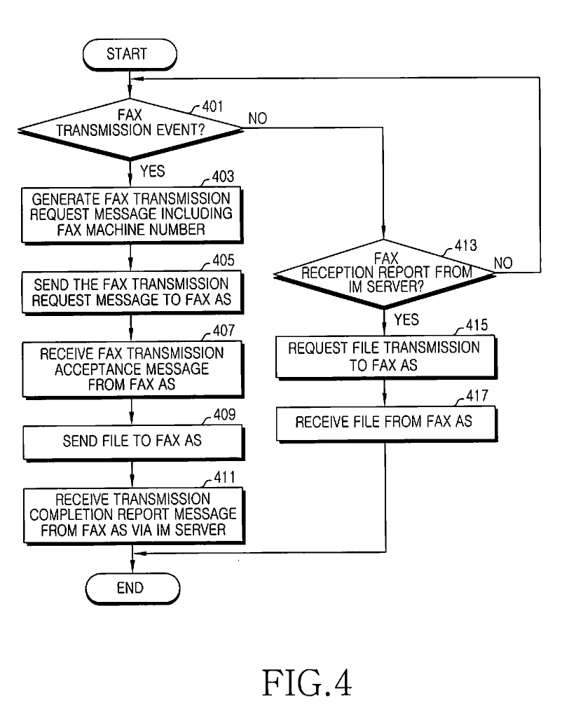

FIG. 4 illustrates the fax transmission and reception method of the UE in the system according to the present invention.

The UE determines whether the fax transmission event occurs in step 401. When the fax transmission event occurs, the UE generates the fax transmission request message including the recipient fax machine number in step 403. In step 405, the UE sends the generated fax transmission request message to the FAX AS of the IMS network.

The UE receives the fax transmission acceptance message from the FAX AS in step 407 and sends the file to transmit to the FAX AS in step 409. In step 411, the UE receives the message reporting of the completion of the corresponding file transmission from the FAX AS via the IM server of the IMS network. When an error occurs during the file transmission, the UE can receive a message reporting of detailed information relating to the error via the IM server. Then, the UE ends the process.

Meanwhile, when the fax transmission event does not occur in step 401, the UE determines whether the fax reception report message is received from the IM server in step 413. When the fax reception report message is not received, the UE returns to and resumes step 401. When the fax reception report message is received, the UE requests the FAX AS to forward the file corresponding to the received fax in step 415, receives the corresponding file from the FAX AS in step 417, and then ends this process.

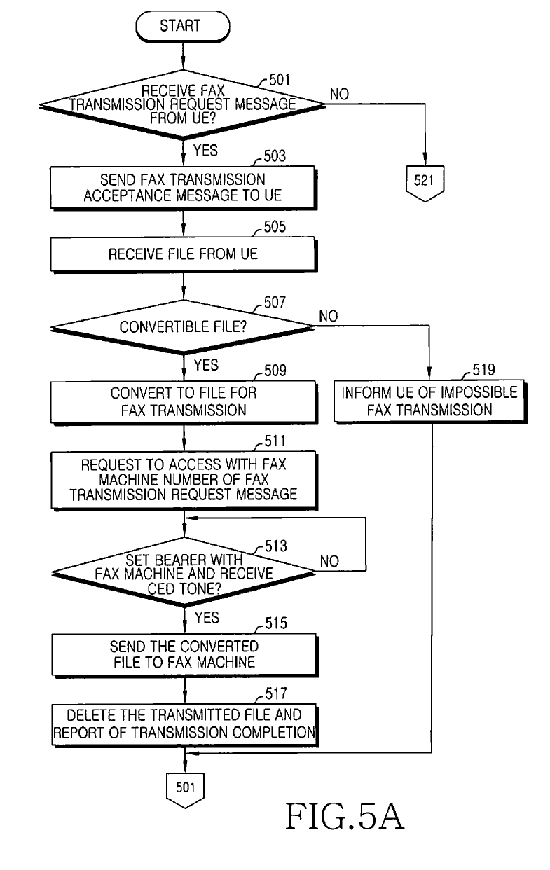

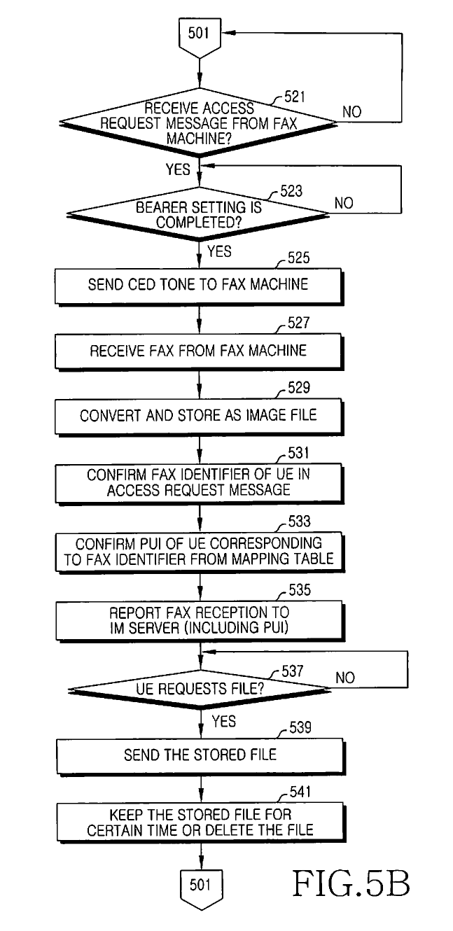

FIGS. 5A and 5B illustrate operations of the FAX AS for providing the fax service in the system according to the present invention.

In step 501, the FAX AS determines whether the fax transmission request message is received from the UE. When the fax transmission request message is received, the FAX AS sends the fax transmission acceptance message to the UE in step 503 and receives the file from the UE in step 505.

In step 507, the FAX AS determines whether the file can be converted to the proper format of the fax transmission. When the file is not convertible, the FAX AS informs the UE of the infeasible fax transmission because of the file conversion failure in step 519 and goes back to step 501. When the file is convertible, the FAX AS converts the file to the proper format of the fax transmission in step 509 and sends the access request message to the corresponding fax machine by identifying the fax machine number of the fax transmission request message in step 511.

In step 513, the FAX AS examines whether the bearer setting to the corresponding fax machine is completed and whether the CED tone is received from the fax machine. When the bearing setting is completed and the CED tone is received, the FAX AS transmits the format-converted file to the corresponding fax machine in step 515, and deletes the transmitted file and reports the fax transmission completion to the UE in step 517. The FAX AS then returns to step 501 and repeats the subsequent step.

By contrast, when a fax transmission request message is not received, the FAX AS determines whether the access request message is received from the fax machine in step 521. When the access request message is not received, the FAX AS returns to step 501. When the access request message is received, the FAX AS determines whether the bearer setting is completed in step 523. Herein, the access request message includes the fax identifier of the UE that is to receive the fax from the fax machine.

When the bearer setting is completed, the FAX AS transmits the 2100 Hz CED tone to the fax machine in step 525, receives the fax from the fax machine in step 527, converts the received fax to an image file and stores the image file in step 529.

Next, the FAX AS confirms the fax identifier of the access request message in step 531 and confirms the PUI of the UE corresponding to the fax identifier from the pre-stored identifier mapping table in step 533. In step 535, the FAX AS sends the message reporting of the fax reception of the PUI to the IM server. Herein, the identifier mapping table arranges the mapping relation between the fax identifiers and the PUIs of the UEs.

When the UE corresponding to the PUI requests the file transmission in step 537, the FAX AS transmits the stored image file to the UE in step 539 and deletes the stored file immediately or after storing the file for a time duration in step 541. Notably, even when the UE corresponding to the PUI does not request the file transmission, the FAX AS is able to delete the file after storing it for a time duration. The FAX AS then returns to step 501.

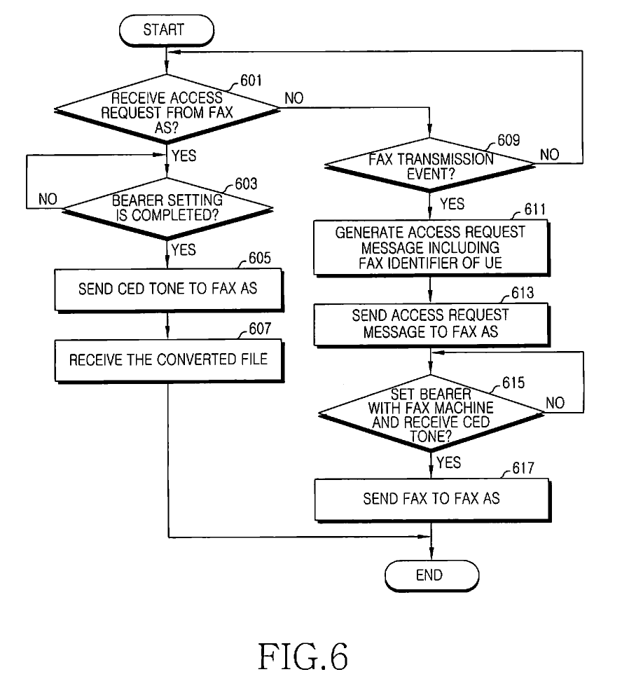

FIG. 6 illustrates the fax transmission and reception method of the fax machine in the system according to the present invention.

In step 601, the fax machine determines whether the access request message is received from the FAX AS. When the access request message is received, the fax machine determines whether the bearer setting is completed in step 603. When the bearer setting is completed, the fax machine transmits the 2100 Hz CED tone to the FAX AS in step 605. The fax machine receives the file converted to the proper format of the fax transmission from the FAX AS in step 607 and then ends this process.

By contrast, when the access request message is not received, the fax machine determines whether the fax transmission event is generated in step 609. When there is no fax transmission event, the fax machine returns to step 601. When there is a fax transmission event to be performed, the fax machine generates the access request message including the fax identifier of the recipient UE in step 611. The fax identifier of the recipient UE can be input from the user.

The fax machine sends the generated access request message to the FAX AS in step 613 and determines whether the bearer setting is completed and whether the 2100 Hz CED tone is received from the FAX AS in step 615. When the bearer setting is completed and the 2100 Hz CED tone is received, the fax machine transmits the fax to the FAX AS in step 617 and then finishes this process.

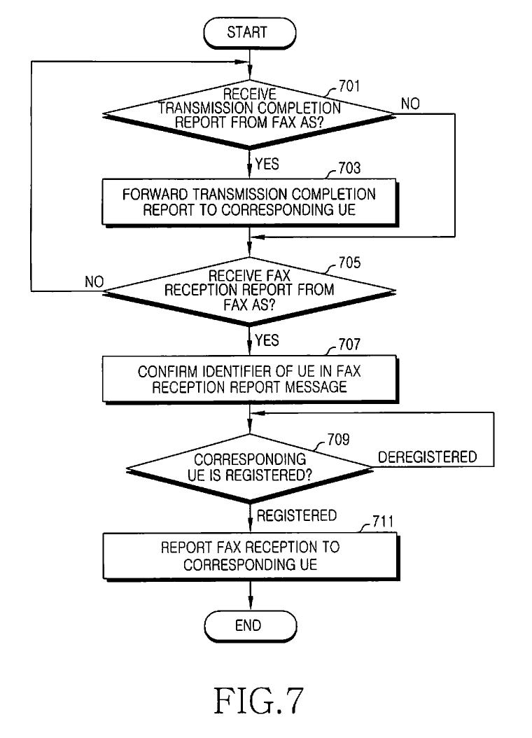

FIG. 7 illustrates operations of the IM server for the fax service in the system according to the present invention.

In step 701, the IM server determines whether the transmission completion report message notifying that the file from the particular UE is transmitted to the corresponding fax machine is received from the FAX AS. Upon receiving the transmission completion report message, the IM server forwards the transmission completion report message to the corresponding UE in step 703 and proceeds to step 705. When no transmission completion report message is received, the IM server proceeds to step 705.

In step 705, the IM server determines whether the fax reception report message is received from the FAX AS; that is, whether the message indicating that the fax destined for the particular UE is received at the FAX AS. When the fax reception report message is not received, the IM server returns to step 701. When the fax reception report message is received, the IM server confirms the PUI of the UE of the fax reception report message in step 707.

In step 709, the IM server examines the registration status of the UE corresponding to the PUI. When the UE is registered, the IM server reports the fax reception to the corresponding UE in step 711. When the UE is deregistered, the IM server periodically examines the registration status of the UE and reports the fax reception to the corresponding UE in step 711 when the UE becomes registered. The IM server then ends this process.

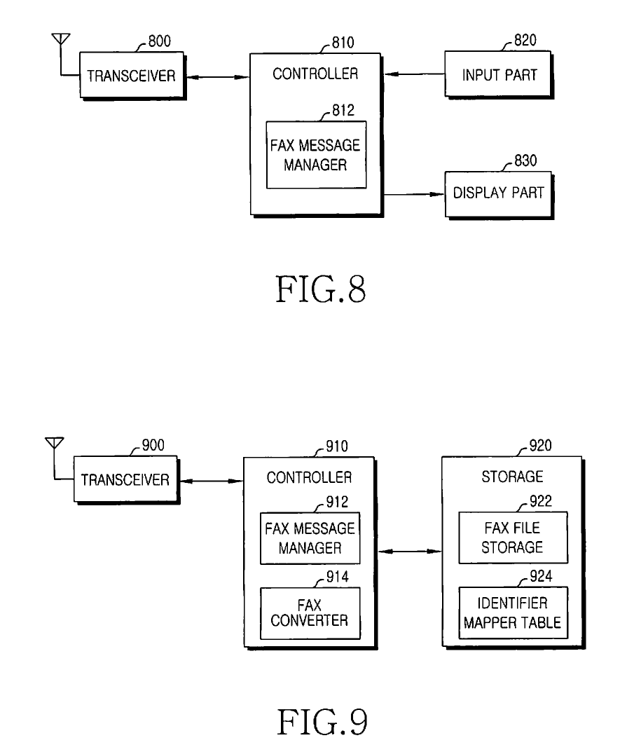

FIG. 8 illustrates the UE in the system according to the present invention.

The UE of FIG. 8 includes a transceiver 800, a controller 810, an input part 820, and a display part 830. The controller 810 includes a fax message manager 812.

The transceiver 800 processes the signals transmitted and received under the control of the controller 810.

The controller 810 controls and processes the operations of the UE. The controller 810 including the fax message manager 812 controls and processes to transmit and receive the fax to and from the FAX AS. Herein, the fax message manager 812 controls and processes to analyze the fax related message received through the transceiver 800, to generate the fax related message, and to send the fax related message to the corresponding node via the transceiver 800.

More specifically, when the event for the fax transmission occurs, the controller 810 controls and processes to generate the message including the recipient fax machine number and to send the message to the FAX AS. When the fax transmission acceptance message is received from the FAX AS, the controller 810 controls and processes to transmit the file to the FAX AS. When the fax reception report message is received from the IM server, the controller 810 controls and processes to generate the message requesting to send the file corresponding to the received fax, to send the generated message to the FAX AS, and to receive the corresponding file from the FAX AS.

The input part 820, which includes a plurality of function keys, number keys, and letter keys, provides key input data corresponding to the key pressed by the user to the controller 810. In particular, the input part 820 receives the key input corresponding to the fax machine number from the user and provides the key input data to the controller 810.

The display part 830 displays status information, limited numbers and letters, videos, and still images in the process of the UE operation. Under the control of the controller 810, the display part 830 can display the file received from the FAX AS and display error in the fax transmission to the user.

FIG. 9 illustrates the FAX AS in the system according to the present invention

The FAX AS of FIG. 9 includes a transceiver 900, a controller 910, and a storage 920. The controller 910 includes a fax message manager 912 and a fax converter 914. The storage 920 includes a fax file storage 922 and an identifier mapping table 924.

The transceiver 900 processes the signals transmitted and received under the control of the controller 910.

The controller 910 controls and processes the operations of the FAX AS. The controller 910 including the fax message manager 912 and the fax converter 914 controls and processes to provide the fax transmission service. Herein, the fax message manager 912 controls and processes to analyze the fax related message received through the transceiver 900, to generate the fax related message, and to transmit the generated message to the corresponding node via the transceiver 900. The fax converter 914 converts the file received from the UE through the transceiver 900 to the proper format of the fax transmission and converts the fax received from the fax machine through the transceiver 900 to the image file.

When the fax transmission request message is received from the UE, the controller 910 generates and sends the fax transmission acceptance message to the UE. When the file is received from the UE, the controller 910 controls and processes to convert the corresponding file to the proper format of the fax transmission, and to send the converted file to the corresponding fax machine and report the fax transmission completion to the UE. When the access request message is received from the fax machine, the controller 910 controls and processes to send the 2100 Hz CED tone to the fax machine, to convert the fax received from the fax machine to the image file, and to send the image file to the corresponding UE.

The storage 920 stores a program and data for the operations of the FAX AS. The storage 920 includes the fax file storage 922 for storing the file converted at the fax converter 914, and the identifier mapping table 924 for arranging the PUIs and the fax identifiers of UEs.

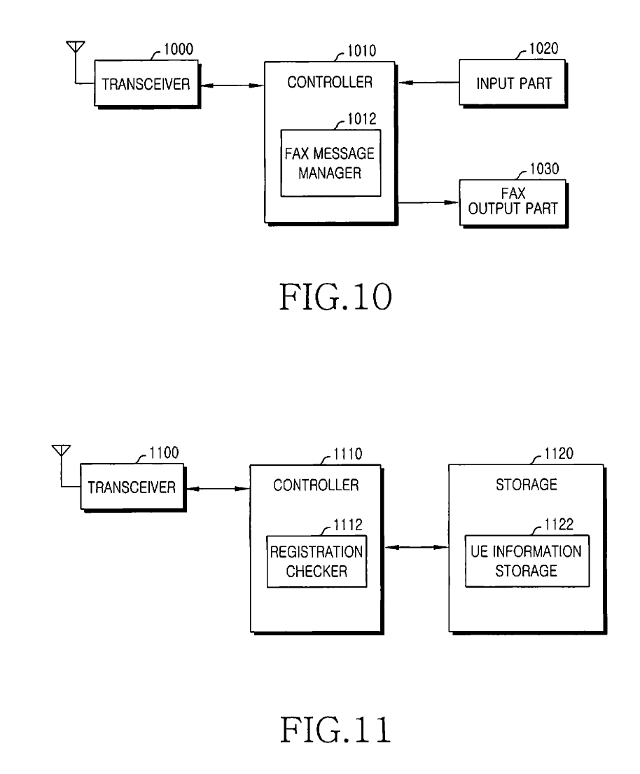

FIG. 10 illustrates the fax machine in the system according to the present invention.

The fax machine of FIG. 10 includes a transceiver 1000, a controller 1010, an input part 1020, and a fax output part 1030. The controller 1010 includes a fax message manager 1012.

The transceiver 1000 processes the signals transmitted and received under the control of the controller 1010.

The controller 1010 controls and processes the operations of the fax machine. The controller 1010 including the fax message manager 1012 controls and processes to transmit and receive the fax to and from the UE via the FAX AS. Herein, the fax message manager 1012 controls and processes to analyze the fax related message received through the transceiver 1000, to generate the fax related message, and to send the fax related message to the corresponding node via the transceiver 1000.

Specifically, when the access request message is received from the FAX AS and the bearer setting is completed, the controller 1010 controls and processes to transmit the 2100 Hz CED tone to the FAX AS and to receive the fax from the FAX AS. When the event for the fax transmission to the UE occurs, the controller 1010 generates and sends the access request message including the fax identifier of the UE to the FAX AS. When the 2100 Hz CED tone is received from the FAX AS, the controller 1010 controls and processes to transmit the fax to the FAX AS.

The input part 1020, which includes a plurality of function keys, number keys, and letter keys, provides key input data corresponding to the key pressed by the user to the controller 1010. In particular, the input part 1020 receives the key input corresponding to the fax identifier of the recipient UE from the user and provides the key input data to the controller 1010.

Under the control of the controller 1010, the fax output part 1030 outputs the fax received from the FAX AS, receives the fax destined for the UE from the user, and forwards the fax to the controller 1010.

FIG. 11 illustrates the IM server in the system according to the present invention.

The IM server of FIG. 11 includes a transceiver 1100, a controller 1110, and a storage 1120. The controller 1110 includes a registration checker 1112, and the storage 1120 includes a UE information storage 1122.

The transceiver 1100 processes the signals transmitted and received under the control of the controller 1110.

The controller 1110 controls and processes the operations of the IM server. The registration checker 1112 determines whether the UE is registered by using the UE information storage 1122.

When the transmission completion report message is received from the FAX AS, the controller 1110 controls and processes to forward the transmission completion report message to the corresponding UE. When the fax reception report message is received from the FAX AS, the controller 1110 examines the registration status of the corresponding UE. When the UE is registered, the controller 1110 controls and processes to forward the fax reception report message to the corresponding UE. When the corresponding UE is deregistered, the controller 1110 periodically examines the registration status. When the UE becomes registered, the controller 1110 controls and processes to forward the fax reception report message to the corresponding UE.

The storage 1120 stores a program and data for the operations of the IM server. The storage 1120 includes the UE information storage 1122 that stores the UE information, such as the registration status and the PUI of the UE.

By providing the fax service using the separate service for the fax service in the IMS, the UE not supporting the T.38 protocol can use the fax service and the IMS network resource can be efficiently utilized. When the originating UE sends the file to the FAX AS, the FAX AS handles the subsequent processes, to thus reduce the fax transmission time of the originating UE. Since the FAX AS receives the fax from the fax machine in lieu of the recipient UE, the user can confirm the fax at his/her intended time. As the fax reception is reported to the recipient UE in association with the FAX AS and the IM server, the stable fax service can be accomplished even when the recipient UE is deregistered or does not respond to the fax transmission signal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of a Facsimile (FAX) Application Server (AS) for providing a fax service in an Internet Protocol (IP) Multimedia Subsystem (IMS), the method comprising:
receiving a fax transmission request from a User Equipment (UE) or a fax machine;
interconnecting the UE and the fax machine over an IMS network; and
sending a fax to transmit and receive between the UE and the fax machine through the connection.

2. The method of claim 1, wherein the receiving of the fax transmission request from the UE or the fax machine comprises:
receiving a fax transmission request message including one or more fax machine numbers and a fax file from the UE.

3. The method of claim 2, further comprising:
converting the fax file received from the UE into a fax transmission format and sending the converted fax file to a fax machine corresponding to the one or more fax machine numbers.

4. The method of claim 1, wherein the receiving of the fax transmission request from the UE or the fax machine comprises:
receiving an access request message comprising a fax identifier of a particular UE and a fax file from the fax machine.

5. The method of claim 4, further comprising:
converting the fax file received from the fax machine to an image file and sending the converted image file to the particular UE corresponding to the fax identifier.

6. The method of claim 5, further comprising:
examining a registration status of the UE corresponding to the fax identifier;
when the UE is not registered, periodically examining the registration status until the UE is registered; and
when the UE is registered, sending the fax file received from the fax machine to the UE through the connection.

7. The method of claim 1, further comprising:
storing the fax for a time duration.

8. A method of a User Equipment (UE) for providing a facsimile (fax) service in an Internet Protocol (IP) Multimedia Subsystem (IMS), the method comprising:
sending a fax transmission request message including one or more fax machine numbers and a fax file to a FAX Application Server (AS) of an IMS network; and
receiving a fax file from a particular fax machine via the FAX AS.

9. The method of claim 8, wherein the fax file sent to the FAX AS of the IMS network is in a fax transmission format or in a format other than the fax transmission format.

10. An apparatus of a Facsimile (FAX) Application Server (AS) for providing a fax service in an IP Multimedia Subsystem (IMS), the apparatus comprising:
a controller for receiving a fax transmission request from a User Equipment (UE) or a fax machine, and controlling to send a fax to transmit and receive between the UE and the fax machine by interconnecting the UE and the fax machine over an IMS network.

11. The apparatus of claim 10, further comprising:
a transceiver for receiving a fax transmission request message including one or more fax machine numbers and a fax file from the UE, and providing the received message and fax file to the controller.

12. The apparatus of claim 11, wherein the controller controls to convert the fax file received from the UE into a fax transmission format and to send the converted fax file to a fax machine corresponding to the one or more fax machine numbers.

13. The apparatus of claim 10, further comprising:
a transceiver for receiving an access request message including a fax identifier of a particular UE and a fax file from the fax machine, and providing the received message and fax file to the controller.

14. The apparatus of claim 13, wherein the controller controls to convert the fax file received from the fax machine to an image file and to send the converted image file to the particular UE corresponding to the fax identifier.

15. The apparatus of claim 14, wherein the controller examines a registration status of the UE corresponding to the fax identifier, periodically examines the registration status until the UE is registered when the UE is not registered, and controls to send the fax file received from the fax machine to the UE through the connection when the UE is registered.

16. The apparatus of claim 10, further comprising:
a storage for storing the fax for a time duration.

17. An apparatus for providing a facsimile (fax) service in an Internet Protocol (IP) Multimedia Subsystem (IMS), the apparatus comprising:
a controller for controlling to send a fax transmission request message including one or more fax machine numbers and a fax file to a FAX Application Server (AS) of an IMS network, and to receive a fax file from a particular fax machine via the FAX AS.

18. The apparatus of claim 17, wherein the fax file sent to the FAX AS of the IMS network is in a fax transmission format or in a format other than the fax transmission format.
